(19) United States
(12) Patent Application Publication
(10) Pub. No.: US 2010/0017471 A1
(43) Pub. Date: Jan. 21, 2010

(54) SYSTEM AND METHOD FOR TRANSMITTING ELECTROCARDIOGRAM DATA

(76) Inventors: William Douglas Brown, Murfreesboro, TN (US); James Andrew Baker, Murfreesboro, TN (US)

Correspondence Address: DORSEY & WHITNEY LLP;INTELLECTUAL PROPERTY DEPARTMENT, SUITE 1500, 50 SOUTH SIXTH STREET, MINNEAPOLIS, MN, 55402-1498, US

(21) Appl. No.: 12/191,107

(22) Filed: Aug. 13, 2008

Related U.S. Application Data
(60) Provisional application No. 61/080,925, filed on Jul. 15, 2008.

(51) Int. Cl. G06F 15/16

(52) U.S. Cl. 709/204

(57) ABSTRACT

The present disclosure relates to systems and methods for providing improved medical care. A system includes a defibrillator, a gateway device, a routing device, and a wireless modem. The system may further include hardware and/or software components located at a remote facility for receiving data and one or more server devices for decoding data from the remote facility. A method includes acquiring medical data at a first location, converting the medical data from an analog signal to a digital signal, transmitting the digital signal from the first location to a second location over the internet via a cellular network, receiving the digital signal at the second location, and converting the digital signal back to an analog signal for processing. The first location may be an EMS vehicle, and the second location may be a remote facility, such as a dispatch center or local hospital.

### CROSS-REFERENCE TO RELATED APPLICATION

This application claims benefit of U.S. Provisional Application No. 61/080,925 filed Jul. 15, 2008, the contents of which are incorporated herein by reference.

### FIELD OF THE INVENTION

The present disclosure relates to systems and methods for transmitting medical data. More particularly, the present disclosure relates to systems and methods for transmitting electrocardiogram (“EKG”) or defibrillator data. Even more particularly, the present disclosure relates to systems and methods for transmitting EKG or defibrillator data from an emergency medical service (“EMS”) vehicle, such as an ambulance, over a network to, for example, a dispatch center, hospital, etc.

### BACKGROUND OF THE INVENTION

An EKG process is started by paramedics after the patient has been placed in the EMS vehicle. Typically, a paramedic will attach leads, or electrodes, from a defibrillator to the body of the patient at various locations. A lead records the electrical signals of the heart. The defibrillator records and turns the electrical signals into a graphic representation of the electrical activity. The graphic representation depicts the electrical activity of the heart over time, thereby making the behavior of the heart interpretable by trained personnel. The graphic representation may indicate the overall rhythm of the heart as well as weakness in different parts of the heart muscle. This procedure represents the generally accepted best practice for measuring and diagnosing abnormal rhythms of the heart. The paramedic can then perform certain procedures or administer certain heart medications to stabilize the patient.

However, in a transport environment, the options available to a paramedic are somewhat limited by training and by pharmaceutical availability in terms of medical care that the paramedic can provide. Similarly, hospital-based preparations prior to a patient arrival are limited to verbal descriptions of the patient's condition and the heart's behavior based on the paramedic's interpretation. There is a need and potential for benefit of being able to transmit EKG or defibrillator data to the hospital prior to the patient's arrival at the hospital. Similarly, it could be beneficial to transmit second EKG or defibrillator data from a patient after medications, or other treatment, has been administered, in order to illustrate how the behavior of the patient's heart has reacted or responded to the medication or treatment.

The cost for replacing older model defibrillators with new defibrillators having the potential capability of transmitting EKG or defibrillator data is excessive, and in some cases can cost upwards of $25,000 or more per unit. In many cases, more than one defibrillator would need to be replaced, correspondingly increasing the total cost of replacement.

Additionally, the methods used by even the newer model defibrillators are cumbersome, slow, and result in EKG and defibrillator data that is insufficient in quality. Such methods include sending a transmission, similar to a fax transmission, from the defibrillator to a remote station. The remote station will then forward the transmission to the local hospital(s). Such methods result in substantially low quality, i.e., fax quality, graphic representations of EKG and defibrillator data. These low quality transmissions make it hard for trained personnel at the hospital to advise appropriate treatment. Furthermore, total transmission time from the EMS vehicle, through the remote station, to the local hospital(s) can typically be in the range of six to eight minutes.

Thus, there exists a need in the art for improving emergency care, including providing systems and methods by which to transmit EKG or defibrillator data. Particularly, there is a need in the art for systems and methods for transmitting EKG or defibrillator data from an EMS vehicle, such as an ambulance, over a network to, for example, a dispatch center, hospital, etc. that results in quicker transmission of EKG or defibrillator data from the EMS vehicle, and in most cases prior to the patient's arrival at a hospital. Furthermore, there is a need in the art for a cost-effective option for transmitting EKG and defibrillator data using defibrillator models not capable of doing so on their own, where the cost-effective option costs substantially less than full replacement of a defibrillator. Even further, there is a need in the art for transmitting high quality EKG and defibrillator data from an EMS vehicle to a hospital, thereby allowing easier and earlier diagnosis from trained personnel at the hospital.

### BRIEF SUMMARY OF THE INVENTION

The present disclosure, in one embodiment, relates to a system for providing improved medical care. The system includes a defibrillator, a gateway device operably coupled to the defibrillator, a routing device operably coupled to the gateway device, and a wireless modem operably coupled to the routing device. The system may further include hardware and/or software components located at a remote facility for receiving a digital signal representing the electrocardiogram and may also include one or more server devices for decoding the digital signal. The one or more server devices may be located at the remote facility or at a location remote from the remote facility.

The present disclosure, in another embodiment, relates to a method for transmitting medical data from one location and receiving the medical data at another location. The method includes acquiring the medical data at a first location, converting the medical data from an analog signal to a digital signal, transmitting the digital signal from the first location to a second location over the internet via a cellular network, receiving the digital signal at the second location, and converting the digital signal back to an analog signal for processing. The first location may be an emergency vehicle, such as an ambulance. The second location may be a local hospital. In alternative embodiments, the second location can be a dispatch center and the method further includes transmitting the digital signal from the dispatch center to one or more servers.

The present disclosure, in yet a further embodiment, relates to a system for transmitting and receiving medical data. The system includes means for acquiring the medical data, means for converting the medical data from an analog signal to a digital signal, means for transmitting the digital signal over the internet via a cellular network, means for receiving the digital signal from the internet, and means for converting the digital signal back to an analog signal for processing. The system may also include hardware and/or software components located at a remote facility for forwarding the digital signal from the internet to one or more locations having the means for converting the digital signal back to an analog signal. The means for converting the medical data from an analog signal to a digital signal can include hardware and software for encoding the analog signal in TCP/IP protocol, and the means for converting the digital signal back to an analog signal for processing can include software for decoding TCP/IP protocol.

While multiple embodiments are disclosed, still other embodiments of the present invention will become apparent to those skilled in the art from the following detailed description, which shows and describes illustrative embodiments of the invention. As will be realized, the invention is capable of modifications in various obvious aspects, all without departing from the spirit and scope of the present invention. Accordingly, the drawings and detailed description are to be regarded as illustrative in nature and not restrictive.

### BRIEF DESCRIPTION OF THE DRAWINGS

While the specification concludes with claims particularly pointing out and distinctly claiming the subject matter that is regarded as forming the present invention, it is believed that the invention will be better understood from the following description taken in conjunction with the accompanying Figures, in which:

FIG. 1 is a schematic of a system for transmitting EKG data in accordance with an embodiment of the present disclosure.

FIG. 2 is a flow chart of a method for transmitting EKG data in accordance with an embodiment of the present disclosure.

### DETAILED DESCRIPTION

The present disclosure relates to novel and advantageous systems and methods for transmitting medical data and improving medical care. More particularly, the present disclosure relates to novel and advantageous systems and methods for transmitting EKG and defibrillator data from an EMS vehicle over a network to a hospital or the like that result in quicker and higher quality transmissions of EKG or defibrillator data from the EMS vehicle, and in most cases prior to the patient's arrival at a hospital. The present disclosure further relates to retrofitting defibrillator models not capable of transmitting such data to a remote destination on their own, where retrofitting the defibrillators is significantly more cost-effective than full replacement of a defibrillator. The various embodiments disclosed herein can improve medical care by allowing easier and earlier diagnosis from trained personnel at the hospital. Future benefits of the various embodiments disclosed herein may include, among other things, the administration of thrombolitics in the EMS vehicle.

Generally, the novel and advantageous EKG systems and methods described herein can provide one or more increased capabilities. A paramedic can use capability built-in to existing defibrillators to transmit EKG and defibrillator data to a hospital for review by cardiac physicians. The systems and methods described herein may utilize a network connection available in the ambulance for this purpose, as well as other purposes that may be useful, such as GPS location, feed transmission from a video camera, such as a webcam, transmission of data from one or more mobile computing devices or other medical devices, etc. In one embodiment, a gateway device may simulate a dial-tone so that the defibrillator believes it is using a conventional analogue telephone connection. The gateway can then translate the data received from the defibrillator into digital internet protocol data traffic. A wireless, or cellular, modem may provide a continual link to a network via a publicly available cellular network connection. The data may be routed to an internet connection or router at a local dispatch center. The dispatch center may substantially instantaneously route the traffic to one or more network servers. In another embodiment, the data may be routed from the EMS vehicle directly to the network servers, bypassing the dispatch center. The network servers may include software for decoding the digital internet protocol traffic back into an analog signal. The network server may then process the analog data. A medical technician, receptionist, or other suitable employee of the dispatch center or administrator of the network server can then display, print, or forward the processed data, for example as a .PDF document, to a physician's computer or handheld device. Preparations can then be made to properly accommodate the patient upon his/her arrival, or the paramedic could be given pre-arrival instructions.

In further embodiments, as stated above, the novel systems and methods described herein may be used to transmit data other than EKG data over a network from an ambulance to, for example, a dispatch center, hospital, etc. For example, the systems and methods described herein may be used to transmit data from, for example but not limited to, a GPS unit, a video camera, such as a webcam, one or more mobile computing devices, other medical devices, etc.

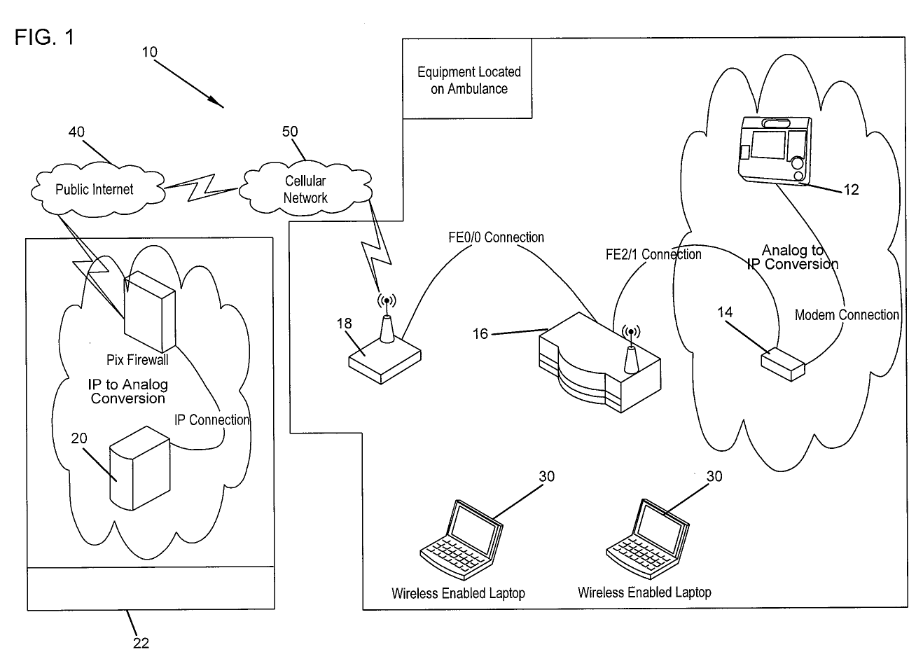

FIG. 1 illustrates one embodiment of a system 10 for transmitting EKG data over a network, such as for example, the Internet and/or cellular network. The system 10 may comprise hardware and/or software components located on a vehicle, such as but not limited to, an EMS vehicle and, in some embodiments, may include hardware and/or software components located at a remote facility or device, such as a dispatch center, hospital or other medical center, emergency center, private residence, such as a physician's residence, or any other location or device suitable for receiving data transmitted over a network.

The hardware and/or software components located on, for example, an EMS vehicle, e.g., ambulance, may comprise a defibrillator 12, such as but not limited to the Physio-Control Lifepak 12 by Medtronic®, or other device capable of providing data to be transmitted from the EMS vehicle. The defibrillator 12 may include a modem or may be otherwise capable of dialing out and sending a transmission of an analog signal representative of the EKG. The analog signal may be sent from the defibrillator 12 to a gateway device 14.

The gateway device 14, for example the Airlink™ RJ-11 IP Gateway, or other device capable of converting protocols among communications networks or otherwise interfacing with another network that uses different protocols, may be operably connected to the defibrillator 12. The gateway device 14 may receive the analog signal from the defibrillator 12 and encapsulate or encode the analog signal to a standard TCP/IP format. The converted signal may then be sent to a router 16.

The router 16, for example the Cisco® 3230 Mobile Access Router, or other device tailored to the tasks of routing and forwarding information, may be operably connected to the gateway device 14. The router 16 may receive the ecapsulated signal from the gateway device 14 and route the signal to a wireless modem 18. The router 16, in further embodiments, may also provide a network access point for other devices in the EMS vehicle. In further embodiments, the router 16 may provide a wireless network access point. For example, the EMS vehicle may have one or more computing devices 30, such as wireless enabled laptops, GPS units, video cameras, such as webcams, or medical devices other than an EKG that can transmit wired or wireless data in a format suitable for transmitting across a network. Each of these devices may be connected to the network via the network access point provided by the router 16.

The wireless modem 18, for example the Airlink™ Pinpoint X wireless modem, or other device for establishing a wireless connection to the Internet or other proprietary network, may be operably connected to the router 16. The wireless modem 18 may provide access to a network, such as the Internet 40, by accessing the Internet 40 through a cellular network 50.

In further embodiments, the system 10 may also include hardware and/or software components located at a remote facility. The hardware and/or software components may comprise a network server 20, or other suitable device for receiving and processing information from a network, such as a personal computer or the like, and other suitable hardware and/or software components 22 for connecting to a network, such as but not limited to a modem (wired or wireless), router, firewall, etc. In some embodiments, the server 20 may include all components necessary to connect to a network and process information received from the network. In further embodiments, the network server 20 may comprise the hardware and/or software components for receiving the EKG and defibrillator data from the Internet 40 and processing the data from the Internet 40 for display, printing, forwarding, analysis, etc. In one embodiment, the network server 20 may include the LifeNet RS Receiving Station by Medtronic®. The network server 20 may include further hardware and/or software components or modifications for decoding the data from Internet from a standard TCP/IP format back to an analog format. In such an embodiment, the LifeNet RS Receiving Station or other suitable hardware/software components may receive the decoded analog signal for processing. In some embodiments, the hardware and/or software components located at a remote facility may be preexisting, and, in such cases, the system 10 can include any further hardware and/or software components for modifying or improving the preexisting components for decoding the EKG and defibrillator data from the Internet 40.

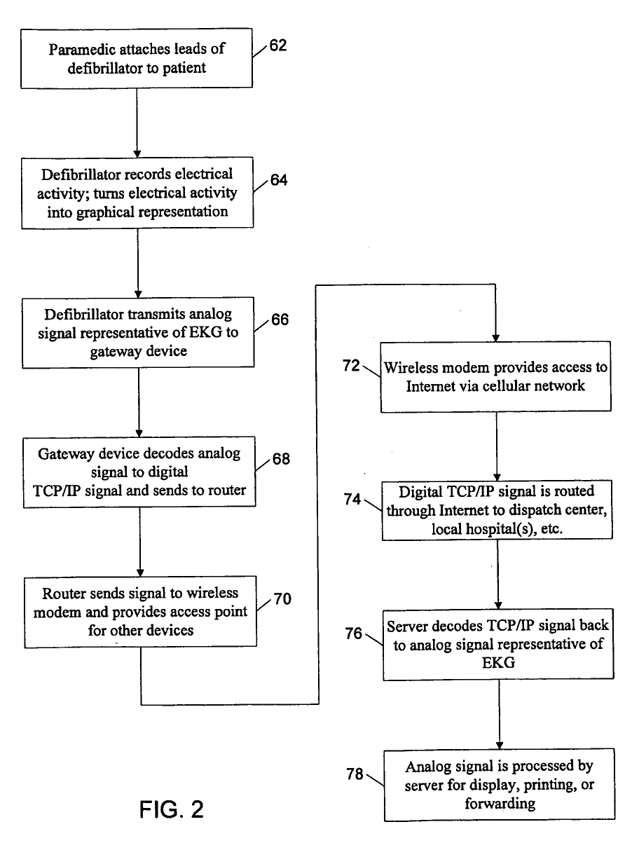

Having described the various components of an embodiment of a system for transmitting EKG or defibrillator data, use of one embodiment of a system for transmitting EKG or defibrillator data will now be described with reference to FIG. 2. An EKG process, as indicated above, can be started by paramedics after the patient has been placed in the EMS vehicle. In step 62, typically, a paramedic will attach leads, or electrodes, from the defibrillator 12 to various locations of the patient's body. A lead records the electrical signals of the heart. In step 64, the defibrillator 12 records and turns the electrical signals into a graphic representation of the electrical activity. In step 66, the defibrillator 12, using a modem or other internal or external device capable of dialing out and sending a transmission of an analog signal, transmits the analog signal representative of the EKG from the defibrillator 12 to the gateway device 14. The gateway device 14, in step 68, receives the analog signal from the defibrillator 12 and encapsulates or encodes the analog signal to a standard TCP/IP format and sends the encoded signal to the router 16. In step 70, the router 16 receives the encoded signal from the gateway device 14 and routes the signal to a wireless modem 18, which, in step 72, provides access to a network, such as the Internet 40, through a cellular network 50. The router 16 may also provide a wired or wireless access point for various other devices, such as those mentioned above. Signals from these other devices may also be routed to the wireless modem 18.

The signal, in step 74, is directed through the Internet 40 to, for example, a dispatch center, local hospital(s), or other suitable location, such as a physician's office or residence, or to a mobile device, such as a mobile PC. The dispatch center or local hospital(s), for example, can route the signal to one or more destinations. At the dispatch center or local hospital(s), the signal, in step 76, is received by the network server 20, and the server 20 decodes the standard TCP/IP signal back into an analog signal. The servers 20 may be located at the dispatch center or local hospital(s), or alternatively, may be located remotely, such as at the destination(s) to which the dispatch center or hospital may have forwarded the encoded signal. In step 78, the decoded analog signal can then be processed appropriately by the server 20 for actions such as display, printing, forwarding, analysis, etc. In further embodiments, an indicator may be used by the server 20 to indicate that a signal, or data, has been received. For example, when an EKG is received, the server 20 may further include an indicator light or LED that can turn on, blink, etc., an alarm or other tone that can be emitted, the server 20 may vibrate, or vibrate a device operably coupled to it or able to receive a signal from the server, such as a pager or an RF or infrared receiver, etc., and/or any other suitable indication device, or any combination thereof.

In some embodiments, the EKG results can be converted to a .PDF format at the server 20. However, it is recognized that any suitable format may be used, such as .GIF, .TIFF, .JPG, .DOC, etc. The .PDF-formatted EKG results may then be easily printed, forwarded, or viewed on a display device. For example, a medical technician, receptionist, or other suitable employee of the dispatch center or hospital monitoring the server 20 may convert the signal to a .PDF format and forward to any number of suitable locations or devices, such as but not limited to, a hospital (if the server 20 is not already located at the hospital), a physician's office or residence, one or more mobile devices, such as a mobile PC or PDA device, including a cellular phone, etc. Preparations can then be made to properly accommodate the patient upon his/her arrival, or the paramedic could be given pre-arrival instructions.

Therefore, the various embodiments of the systems and methods described herein can improve emergency care by providing systems and methods by which to transmit EKG or defibrillator data that result in quicker and higher quality transmission of EKG or defibrillator data from the EMS vehicle, and provide a cost-effective option for transmitting EKG and defibrillator data using defibrillator models not capable of doing so on their own, where the cost-effective option costs substantially less than full replacement of a defibrillator.

Although the present invention has been described with reference to preferred embodiments, persons skilled in the art will recognize that changes may be made in form and detail without departing from the spirit and scope of the invention. For example, although the Airlink™ RJ-11 IP Gateway, Cisco® 3230 Mobile Access Router, and Airlink™ Pinpoint X wireless modem have specifically been mentioned, it is recognized that any suitable gateway device, router, or wireless modem may be used instead of the specifically identified devices. Similarly, although the Physio-Control Lifepak 12 and the LifeNet RS Receiving Station have specifically been mentioned, it is recognized that any suitable defibrillator and process server may be used with the various embodiments disclosed herein.

We claim:

1. A system for providing improved medical care, comprising:
a defibrillator;
a gateway device operably coupled to the defibrillator;
a routing device operably coupled to the gateway device; and
a wireless modem operably coupled to the routing device.

2. The system of claim 1, wherein the defibrillator provides medical data to be transmitted.

3. The system of claim 2, wherein the defibrillator provides an electrocardiogram.

4. The system of claim 3, wherein the gateway device encodes the electrocardiogram into a digital signal for transport across a network.

5. The system of claim 4, wherein the wireless modem provides an access point to the internet via a cellular network.

6. The system of claim 5, further comprising hardware and/or software components located at a remote facility for receiving the digital signal representing the electrocardiogram.

7. The system of claim 6, further comprising one or more server devices for receiving the digital signal from the hardware and/or software components located at the remote facility and decoding the digital signal.

8. A method for transmitting medical data from one location and receiving the medical data at another location, comprising:
acquiring the medical data at a first location;
converting the medical data from an analog signal to a digital signal;
transmitting the digital signal from the first location to a second location over the internet via a cellular network;
receiving the digital signal at the second location; and
converting the digital signal back to an analog signal for processing.

9. The method of claim 8, wherein the medical data is an electrocardiogram and the step of acquiring the medical data at a first location comprises acquiring electrocardiogram data using a defibrillator.

10. The method of claim 9, wherein the first location is an emergency vehicle.

11. The method of claim 10, wherein the second location is a hospital.

12. The method of claim 10, wherein the second location is a remote facility and further comprising transmitting the digital signal from the remote facility to one or more servers.

13. The method of claim 12, wherein the step of converting the digital signal back to an analog signal is done at the one or more servers.

14. The method of claim 10, further comprising processing the analog signal and forwarding to one or more locations or mobile devices.

15. A system for transmitting and receiving medical data, comprising:
means for acquiring the medical data;
means for converting the medical data from an analog signal to a digital signal;
means for transmitting the digital signal over the internet via a cellular network;
means for receiving the digital signal from the internet; and
means for converting the digital signal back to an analog signal for processing.

16. The system of claim 15, further comprising a hardware and/or software at a remote facility for forwarding the digital signal from the internet to one or more locations having the means for converting the digital signal back to an analog signal.

17. The system of claim 15, wherein the means for converting the medical data from an analog signal to a digital signal is a gateway device.

18. The system of claim 15, wherein the means for converting the medical data from an analog signal to a digital signal comprises hardware and software for encoding the analog signal in TCP/IP protocol.

19. The system of claim 18, wherein the means for converting the digital signal back to an analog signal for processing comprises software for decoding TCP/IP protocol.
